(19) United States
(12) Patent Application Publication
(10) Pub. No.: US 2008/0046985 A1
(43) Pub. Date: Feb. 21, 2008

(54) AUTHORIZED DOMAIN MANAGEMENT WITH ENHANCED FLEXIBILITY

(75) Inventors: Peter LENOIR, Eindhoven (NL); Koen Hendrik Johan VRIELINK, Eindhoven (NL); Robert Paul KOSTER, Eindhoven (NL); Sebastiaan Antonius Fransiscus VAN DEN HEUVEL, Eindhoven (NL); Franciscus Lucas Antonius Johannes KAMPERMAN, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,361

(22) PCT Filed: Oct. 11, 2005
(86) PCT No.: PCT/IB05/53330

§ 371 Date: Apr. 17, 2007

(30) Foreign Application Priority Data
Oct. 18, 2004 (EP) 04105108.7

(51) Int. Cl. H04L 9/32

(52) U.S. Cl. 726/6

(57) ABSTRACT

In Authorized Domains the management of which devices that can access content is a key issue. The Authorized Domain must be limited to a relatively small group of devices to get a solution that is acceptable to both content providers and users. However, current solutions are typically either to rigid to be future proof and user friendly or not effective enough in limiting the size of the Authorized Domain. This invention provides a user-friendly, flexible and yet effective method of managing the size of an Authorized Domain. The method proposes to group devices in the Authorized Domain into clusters, if a predetermined requirement is met, and to limit the number of clusters. Such a predetermined requirement could be a proximity requirement.

This invention relates to a method of managing the size of an Authorized Domain arranged to comprise one or more devices. The invention moreover relates to an Authorized Domain Digital Rights Management (AD-DRM) system arranged to perform said method, an Authorized Domain, a program product and a medium readable by a device.

Recent developments in content distribution technologies (i.e. the Internet and removable media) make it easier to exchange content than ever before. The rapid adoption by consumers shows that such technologies really address their needs. A technology for managing access to digital content is Digital Rights Management (DRM) which is the digital management of rights and provides description, identification, trading, protection, monitoring and tracking of all forms of rights usages. DRM enables e.g. content providers, service providers and distributors to protect their content and maintain control over distribution. The content can be protected and/or managed by creating restrictions for each piece of (digital) content or for the devices accessing the content.

A special instance of a DRM system is the Authorized Domain Digital Rights Management (AD-DRM) system, which is a system performing the management of rights in an Authorized Domain. An Authorized Domain can be seen as an environment of devices, media, rights and users, where users and devices handle content according to the rights, but with a relative freedom if performed within the boundaries of the Authorized Domain.

Typically, the Authorized Domain is defined by a household with a home network having a limited number of users and a number of devices centred around the home network. Of course, other scenarios are possible, such as a company network. In an Authorized Domain, typically all devices can access the content associated with that particular Authorized Domain. Moreover, a user could take a portable device for audio and/or video with a limited amount of content with him on a trip and use it in his hotel room to access content stored on his personal audio and/video system at home or download additional content. Even though the portable device is outside the home network, it is a part of the user's Authorized Domain. Thus, managing access to content is turned into managing the extent or size of an Authorized Domain. Therefore, in Authorized Domains, the management of which devices are/can be part of a specific domain is a key issue. Inherent to the concept of Authorized Domains is the fact that the size of the domain must be limited to a relatively small group of devices to get a workable solution, i.e. a solution that is acceptable to both the content industry and the consumers. Throughout this patent specification the term “size” of an Authorized Domain is a measure of the number of devices in said Authorized Domain.

To meet content providers' and service providers' needs, exchange between different households and use of content should be controllable. However, limitation on the free use of content will always be a nuisance to consumers/users. The Authorized Domain concept is designed to provide the user with a sense of freedom in this limited environment. With this concept the problem of limiting the freedom of consumers/users is transferred largely from the use of content to the configuration of the domain.

The focus of most proposals in relation to determining whether content is being used legally or illegally has until now resulted in methods and/or measures for limiting the size of the Authorized Domain. These typically fall into one of the following two categories:
Limitation measures that focus on a simple enforceable implementation.
Limitation measures that focus on the user experience in an effort not to be noticeable by the general users.

Typically, the former limitation measures impose quite rigid bounds on the size of the Authorized Domain, e.g. a fixed maximum number of devices that can be part of the same Authorized Domain. Even though this enforces a very concrete limitation on the number of devices that content can be accessed from and thereby is easily enforceable, drawbacks by these limitation measures are that they are not really user friendly and that they are not future proof due to the rigidity thereof. Moreover, these measures do not limit an Authorized Domain to a household, in that devices of a neighbour or of family members, who are not part of the household, could have devices that are part of the Authorized Domain.

The latter type of limitation measures typically has easy circumvention mechanisms rendering them unacceptable. For example, a very simple session based policy in which only the number of concurrent sessions is limited is a user friendly limitation measure for Authorized Domains, which, however, is easily circumvented/abused, because it allows for many different persons distributed over a large area to access content in the Authorized Domain, e.g. by using the Internet.

Among the known limiting methods and/or measures are:
Limiting the size of a home (or primary) network to a hard fixed number of devices;
Limiting the number of sessions a person in a domain/network can render, in that persons can only register a limited number of simultaneously activities. Therefore, a natural limit to the content is the number of sessions that one person would need. Thus, the number of sessions inside the network would be proportional to the number of members in the network. In this case, the number of devices becomes irrelevant, in that it is the number of sessions that is the limiting factor. See international patent application WO 03/092264 (attorney docket PHNL020372).
Limiting through registration. Users should register their Authorized Domain and the devices belonging to it at a registration authority. The registration authority keeps track of the size of the Authorized Domain and also for any unusual behaviour in domain management actions, such as a registration of an excessively large number of new devices. An example of a system with such a measure is xCP. A further development of the limiting registration measure is to let a user register at a higher authority in case of reaching the upper limit of devices. This could be related to a higher cost.
Limiting through proving liveliness. Devices, that are members of an Authorized Domain must now and then prove that they are still legitimate members of the domain, e.g. that they interact with other devices in the Authorized Domain or with a central device in the Authorized Domain or they should rerun their registration procedure at certain time intervals. See e.g. international patent application WO 03/092264 (attorney docket PHNL020372).
Limitation measures based on a proximity principle. These are in line with the principle that the Authorized Domain should be limited to one single household. Devices that are close together have a large probability of being related to one single household. Several methods exist to prove such proximity, such as specific distance measuring subsystems based on GPS or on authenticated distance measuring protocols. See for instance international patent application WO 04/014037 (attorney docket PHNL020681) and European patent application serial number 04104717.6 (attorney docket PHNL041038). However, in some situations devices are not necessarily close together even though they belong to persons in an Authorized Domain (e.g. audio and/or video devices in the car or a television set in a second home) and therefore also should be regarded as part of the Authorized Domain.

It is an object of the invention to provide a method of managing the size of an Authorized Domain, which is acceptable both to both content providers and users in that it, at the same time, is substantially proof against circumventions and relatively flexible.

This object is achieved by the method of the invention, in that it comprises the steps of (a) defining a device as belonging to a cluster in the Authorized Domain, if a predefined requirement is met by any two devices within said cluster; (b) defining a device for which said predefined requirement cannot be met between said device and any other device in the Authorized Domain as a cluster in itself; (c) performing the steps (a) and (b) until each of said one or more devices is defined to belong to a cluster; and (d) limiting the size of the Authorized Domain by limiting the number of clusters in the Authorized Domain to a maximum.

Hereby, a limiting method with the benefits of the concept of limiting the size of a network to a hard fixed number of devices and the concept of limitation measures based on a proximity principle is achieved, in that the proximity principle is one example of a predefined requirement. However, the method of the invention is more flexible than the concept of limiting the size of a network to a hard fixed number of devices and it overcomes the problem that it is not always possible to check if all devices meet a predefined requirement in the proximity principle. Moreover, devices in e.g. a car or a second home can still be a part of the Authorized Domain even though they do not meet a proximity requirement. Thus, the method provides an enhanced flexibility in a reasonable balancing of content provider's and user's needs. It should be noted, that it is conceivable to let said maximum be adjustable over time or circumstances, hereby providing a further flexibility. The term “device” is meant to cover any device capable of processing content, such as, but not limited to: a radio receiver, a DVD player, a CD player, a CD-ROM player, a television, a VCR, a tape deck, a personal computer, an MP3 player, a tuner/decoder, a Set Top Box, a mobile phone.

The method of the invention can be performed by an Authorized Domain Manager, which is a device in the Authorized Domain managing the AD-DRM system. Typically, the Authorized Domain Manager is integrated into one of the devices in the Authorized Domain; however, the Authorized Domain Manager might also be a distinct device used mainly for the purpose of regulating and/or managing the Authorized Domain and content access therein.

In a preferred embodiment, said predefined requirement is a proximity requirement. Often, the proximity requirement is met by two devices, if they are very close together, so that they can be seen as forming a functional unit, e.g. a home movie set. However, it could also be conceivable that the proximity requirement is met by devices within a range of several meters from each other. The proximity could be determined by determining the position of each device by means of GPS (Global Positioning System), by distance measurements between the devices or by an upper bound of the technology used, e.g. the maximum distance the signal of a certain wireless technology (NFC, Bluetooth, 802.11b) or the maximum length of a certain cable, e.g. 1394, Ethernet. Alternatively the distance is determined by measuring the time of flight of a physical object between two devices as described in European patent application serial number 04104717.6 (attorney docket PHNL041038). This embodiment provides a relatively easy way to determine whether the predefined requirement is met by any devices and thereby to define the clusters.

In another preferred embodiment, the method according to the invention further comprises the step of limiting the parallel access to content within any cluster. Hereby, enhanced security against fraudulent use of content is achieved. In the case of e.g. a home cinema system, whereof the devices have been defined as forming a cluster, one parallel content access could be the playing of a DVD, while the two parallel content accesses of playing a CD and watching television at the same time is not possible.

In yet a preferred embodiment of the method further comprises the step of: (f) storing the definition of clusters. Hereby, the definition of clusters can be retrieved, e.g. by the Authorized Domain Manager, for the purpose of e.g. redefining the set of clusters at any domain management action or checking whether a device is part of a cluster. Preferably, the method moreover comprises the step of: (g) updating the definition of clusters upon any domain management action (DMA). The term “domain management action” is meant to cover any change of the number of or constellation of devices in the Authorized Domain, such as the addition or removal of a device to or from the Authorized Domain or the movement of a device from e.g. a room to another, so that it might be defined to belong to a different cluster in the Authorized Domain. The term “update” is meant to cover the repeated performance of the method steps (a) to (c). Preferably, the term “update” also includes the repeated storage of the (new) definition of clusters. This embodiment provides a relatively easily feasible way of keeping track of which devices are parts of the Authorized Domain.

Preferably, the method of the invention further comprises the step of (h) making each device in each cluster verify that the predefined requirement between said device and any other device in the appropriate cluster is met. Hereby, enhanced security against fraudulent use of content is achieved. The step of making the devices verify that the requirement is met can be performed by means of instructing the devices to perform the verification; however, the devices could also be hardcoded to perform this step.

In a preferred embodiment, said verification is performed continuously. This also enhances the security in the Authorized Domain against fraudulent use of content. It should be noted that the term “continuously” is meant to cover any regular verification performed at short time intervals, such as once every second or once every minute. In an alternative, preferred embodiment said verification is performed upon any content access on any device in the Authorized Domain. When the devices only need to verify their proximity when accessing content, the power consumption of the devices are reduced in comparison with continuous verification, whereas a high level of security is maintained. The two above embodiments presupposes that it is possible to check the proximity of the devices regularly. However, when this is the case, this regular proximity check renders it possible that the ADM-system should only need to:
1. keep track of the clusters defined in the past;
2. check if a new device is close to an existing cluster;
3. if the new device is close to an existing cluster, add the device to this cluster and instruct it to verify that it is in proximity with all devices in said cluster (continuously or at any content access);
4. if the new device is not close to an existing cluster, add the new device as a single device cluster, if the resulting number of clusters stay below the fixed number of clusters in the Authorized Domain.

It should be noted, that in the above the term “a device is close to a cluster” is meant to cover that a proximity requirement is met by said device and all devices in said cluster. Moreover, it should be noted that said verification could be performed by the devices themselves or by the ADM system.

In yet a preferred embodiment, the steps (a) to (d) are performed at any domain management action. Hereby, the definition of clusters becomes independent of content access and time. At any domain management action the definition is performed from scratch. However, between domain management actions no definition of clusters are performed or verified. This has the advantage of not relying on the availability of a continuous or regular distance measurement system, in that proximity is only determined during device registration and cluster definition. In order to be acceptable for content providers, it is not assumed that clusters previously defined are still valid.

The invention moreover relates to an Authorized Domain Digital Rights Management (AD-DRM) system, the advantages of which correspond to the advantages of the method as described above.

These and other aspects of the invention will be apparent from and elucidated with reference to the embodiments described hereinafter.

The invention will be explained more fully below in connection with a preferred embodiment and with reference to the drawing, in which:

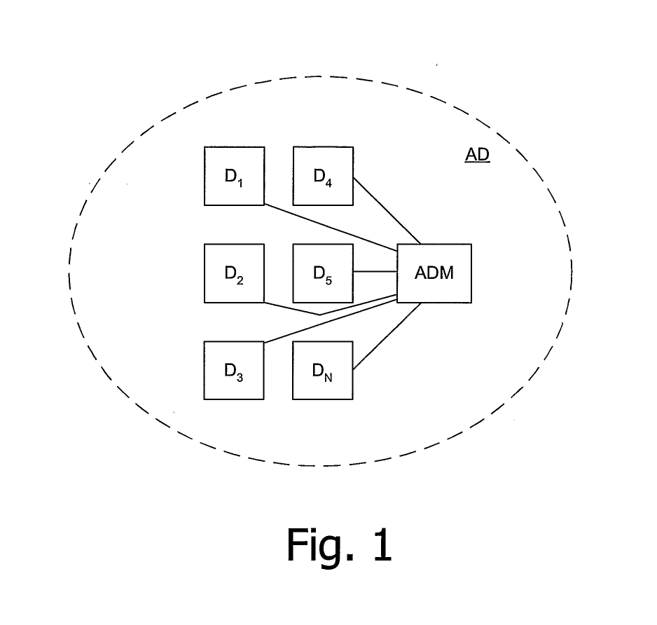

FIG. 1 is a schematic drawing of an Authorized Domain,

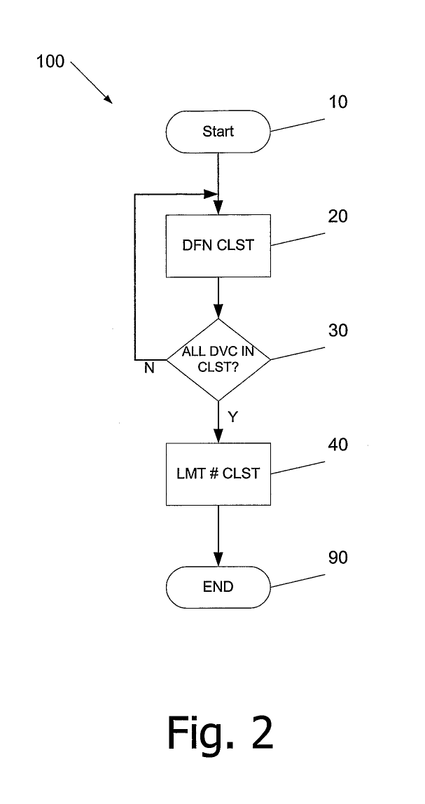

FIG. 2 is a flow chart of a method according to invention, and

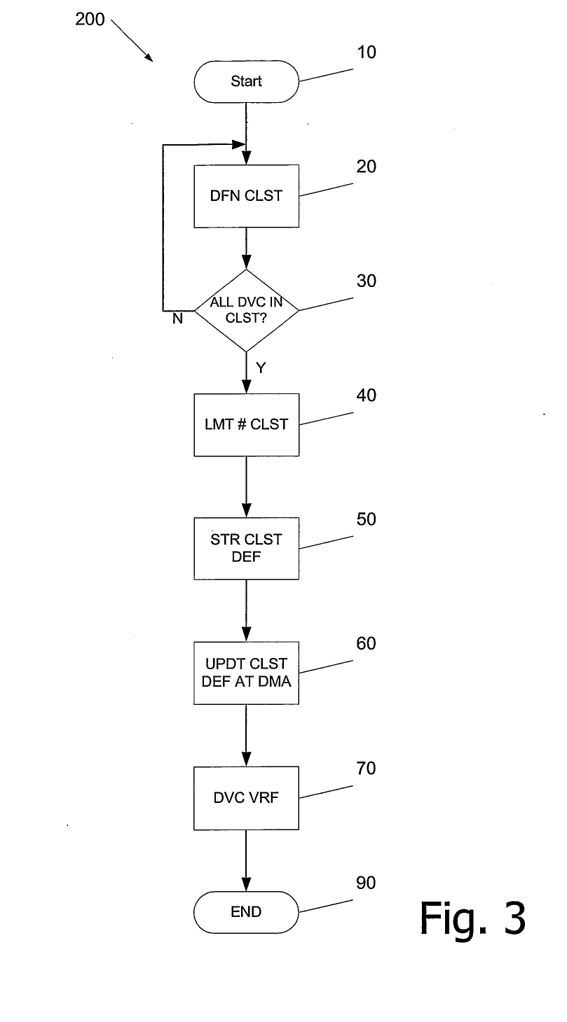

FIG. 3 is a flow chart of an expanded method of the invention.

FIG. 1 is a schematic drawing of an Authorized Domain AD. The Authorized Domain AD comprises N devices D₁, D₂, . . . , D_{N}, where N is a natural number. Examples of such devices are: a radio receiver, a DVD player, a CD player, a CD-ROM player, a television, a VCR, a tape deck, a personal computer, an MP3 player, a tuner/decoder, a Set Top Box. The devices are arranged to access content, such as music, movies, television programs, pictures, text, books, etc.

The devices could contain storage media, such as hard disk, for recording of and later play back of content. Alternatively, the devices could contain means for receiving and immediately playing back content.

The Authorized Domain AD moreover comprises an Authorized Domain Manager ADM. Each of the devices, Dᵢ, has a communication channel to the Authorized Domain Manager ADM. These communication channels can be either wireless connections or conventional wired connections and they might be available for or during AD management operations only or continuously. However, it is also conceivable that a device has a communication channel to another device, which has a communication channel to the Authorized Domain Manager, instead of having a direct communication channel to the Authorized Domain Manager itself.

In some architectures management functionality is handled in a distributed fashion, so that no Authorized Domain Manager ADM is needed.

As shown in FIG. 1, the Authorized Domain Manager ADM can be a separate device, or it could be integrated into one or more of the devices, Dᵢ, iε [1; N] as an Authorized Domain Manager (ADM) functionality. The Authorized Domain Manager ADM/ADM functionality regulates the Authorized Domain by means of the plurality of restriction functions. Thus, the functions of the Authorized Domain Manager ADM e.g. comprises: communicating with the devices Dᵢ for updating which devices are part of the Authorized Domain, registering and limiting the number of devices in the Authorized Domain AD, registering and limiting the number of changes of devices in the Authorized Domain AD, registering the contact period between the ADM and each device Dᵢ in the Authorized Domain, etc., in accordance with the restriction functions in the plurality of restriction functions used in the Authorized Domain AD. Thus, the Authorized Domain Manager ADM decides whether a new device can be added to the Authorized Domain. Moreover, the Authorized Domain Manager ADM also implements consequences in a case where one or more of the limits of the restriction functions in the plurality of restriction functions are exceeded. Examples of such consequences could be: preventing one or more of the devices Dᵢ from accessing content, preventing the devices in the Authorized Domain from unauthorized copying of content and/or from unprotected leaking of content to unauthorized devices, prompting a user to perform actions and/or suggesting any such actions to be performed by the user to remedy any exceeding of the limits of the restriction functions, etc.

The devices Dᵢ in the Authorized Domain AD can be arranged to retrieve content from integrated storage media, such as hard disks, or removable storage media, such as DVDs, CDs, video tapes, cassette tapes, etc. Moreover, any of the devices Dᵢ could be arranged for retrieving content from devices outside the Authorized Domain by means of a radio connection, an Internet connection, a broadband cable network, a satellite downlink, etc. (not shown in FIG. 1).

Some particular architectures of authorized domains have been outlined in international patent application WO 03/098931 (attorney docket PHNL020455), European patent application serial number 03100772.7 (attorney docket PHNL030283), European patent application serial number 03102281.7 (attorney docket PHNL030926), European patent application serial number 04100997.8 (attorney docket PHNL040288) and F. Kamperman and W. Jonker, P. Lenoir, and B. vd Heuvel, Secure content management in authorized domains, Proc. IBC2002, pages 467-475, September 2002. Authorized domains need to address issues such as authorized domain identification, device check-in, device check-out, rights check-in, rights check-out, content check-in, content check-out, as well as domain management.

FIG. 2 is a flow chart of a method 100 according to invention. The flow starts in step 10 that is succeeded by step 20, wherein clusters are defined. A device is defined as belonging to a cluster in the Authorized Domain, if a predefined requirement is met by any two devices within said cluster. In the following, it is assumed that the predefined requirement is a proximity requirement. All devices within one cluster should meet the proximity requirement with all other devices therein. Thus, the devices constituting e.g. a home cinema system or a hi-fi system could be regarded as one cluster. If a device does not meet the proximity requirement with any other device, it is defined as a cluster in itself. This could be the case for devices in a car, in a distant room in a house, in a second home or portable consumer devices. Moreover, all devices that do not have any means for determining proximity or distance to other devices should also be defined as a cluster in itself.

The flow continues at step 30, wherein it is assessed whether all devices in the Authorized Domain have been defined as belonging to exactly one cluster. If this is not the case, step 20 and 30 is performed again, until it is determined, that each device belongs to exactly one cluster. Thereafter, step 40, the number of clusters is limited to a maximum number of clusters. If the number of clusters defined in steps 20 and 30 is equal to or below said maximum, no further limitation is necessary, and the flow ends in step 90. However, if said number of defined clusters is above the maximum number of clusters in the Authorized Domain, the number of clusters must be limited. This limitation could be performed by excluding one or more of the clusters from the Authorized Domain or by moving some of the devices closer together to form larger clusters and thereby reduce the number of clusters. After any of these two or other limitation actions has been performed, it could be necessary to repeat the steps 20 and 30 to check if the newly defined clusters meet the proximity requirement as well as the requirement regarding the number of clusters. The flow ends in step 90.

As noted above, the proximity could be determined by determining the position of each device by means of GPS (Global Positioning System), by distance measurements between the devices (performed by the devices themselves) or by an upper bound of the technology used, e.g. the maximum distance the signal of a certain wireless technology (NFC, Bluetooth, 802.11b) or the maximum length of a certain cable, e.g. 1394, Ethernet.

FIG. 3 is a flow chart of an expanded method 200 of the invention. The steps 10 to 40 are equivalent to the steps 10 to 40 in the method 100 and will not be described in detail again. The steps 10-40 could be performed upon a setup of a new Authorized Domain or upon any Authorized Domain Management action, such as addition or removal of a device. After step 40, the flow continues to step 50, wherein the definition of the clusters are stored, e.g. in a storage medium in one of the devices in the Authorized Domain. The definition of clusters will meet both the proximity requirement within each cluster as well as the requirement as to the maximum number of clusters because of the steps 20-40 performed before step 50. After step 50 the flow continues to step 60, where the definition of clusters are updated. The method could be arranged to listen for whether any domain management action (DMA) is taking/has taken place and in that case performing step 60. Herein, “update” could be achieved by retrieving the definition of clusters, changing it corresponding to the change of clusters or devices in clusters and storing it again. Thus, the domain management action of removing a device from or adding a device to a cluster can be performed, if the device meets the necessary proximity requirements, without having to redefine the clusters that are not affected.

After step 60, the flow could continue to the optional step 70, wherein the devices within the clusters verify their proximity to each other. This could be done continuously, at each content access or at domain management actions, and it enhances the security with regard to unauthorized content access. The flow ends in step 90.

1-21. (canceled)

22. A method of managing the size of an Authorized Domain arranged to comprise one or more devices, comprising the steps of:
defining a device as belonging to a cluster in the Authorized Domain, if a predefined requirement is met by any two devices within said cluster;
defining a device for which said predefined requirement cannot be met between said device and any other device in the Authorized Domain as a cluster in itself;
performing the defining steps until each of said one or more devices is defined to belong to a cluster; and
limiting the size of the Authorized Domain by limiting the number of clusters in the Authorized Domain to a maximum.

23. A method according to claim 22, wherein said predefined requirement is a proximity requirement.

24. A method according to claim 22, further comprising the step of limiting the parallel access to content within any cluster.

25. A method according to claim 22, further comprising the step of storing the definition of clusters.

26. A method according to claim 22, further comprising the step of updating the definition of clusters upon any domain management action.

27. A method according to claim 22, further comprising the step of making each device in each cluster verify that the predefined requirement between said device and any other device in the appropriate cluster is met.

28. A method according to claim 27, wherein said verification is performed continuously.

29. A method according to claim 27, wherein said verification is performed upon any content access on any device in the Authorized Domain.

30. A method according to claim 22, wherein the steps are performed at any domain management action.

31. An AD-DRM system for managing the size of an Authorized Domain arranged to comprise one or more devices, comprising:
means for defining a device as belonging to a cluster in the Authorized Domain, if a predefined requirement is met by any two devices within said cluster;
means for defining a device for which said predefined requirement cannot be met between said device and any other device in the Authorized Domain as a cluster in itself;
means for ensuring that said one or more devices are defined to belong to a cluster; and
means for limiting the size of the Authorized Domain by limiting the number of clusters in the Authorized Domain to a maximum.

32. A system according to claim 31, wherein said predefined requirement is a proximity requirement.

33. A system according to claim 31, further comprising means for limiting the parallel access to content within any cluster.

34. A system according to claim 31, further comprising storage means for storing the definition of clusters.

35. A system according to claim 31, further comprising means for updating the definition of clusters upon any domain management action.

36. A system according to claim 31, further comprising means for making each device in each cluster verify that the predefined requirement between said device and any other device in the appropriate cluster is met.

37. A system according to claim 36, wherein said system is arranged for performing said verification continuously.

38. A system according to claim 36, wherein said system is arranged for performing said verification upon any content access on any device in the Authorized Domain.

39. A system according to claim 31, wherein said system is arranged to performing said definition of clusters at any domain management action.
